(19) United States
(12) Patent Application Publication
(10) Pub. No.: US 2018/0011977 A1
(43) Pub. Date: Jan. 11, 2018

(54) DATA ANALYSIS SYSTEM, DATA ANALYSIS METHOD, AND DATA ANALYSIS PROGRAM

(71) Applicant: UBIC, Inc., Tokyo (JP)

(72) Inventors: Hideki TAKEDA, Tokyo (JP); Akiteru HANATANI, Tokyo (JP)

(21) Appl. No.: 14/902,327

(22) PCT Filed: Mar. 13, 2015
(86) PCT No.: PCT/JP2015/057592

§ 371 Date: Dec. 30, 2015

(51) Int. Cl. G06F 19/00; G06K 9/62; G06Q 50/22

(52) U.S. Cl. CPC G06F 19/345; G06Q 50/22; G06K 9/6262; G06K 9/6256; G06F 19/363

(57) ABSTRACT

A data analysis system according to the present invention includes: a training data acquisition unit that acquires a combination of training data including information about a medicinal drug and a plurality of pieces of classification information for classifying the training data on the basis of a plurality of classification standards; a learning unit that learns a pattern of the information about the medicinal drug from distribution of data elements which constitute at least part of the training data and appear according to the classification information; an unknown data acquisition unit that acquires unknown data from a specified information source; a data evaluation unit that evaluates the acquired unknown data on the basis of the learned pattern with respect to each of the plurality of classification standards; and a presentation unit that presents the information about the medicinal drug included in the unknown data to a user according to evaluation by the data evaluation unit.

### CROSS-REFERENCE TO RELATED APPLICATIONS

The present application is a national phase application of PCT application PCT/JP2015/057592 filed Mar. 13, 2015, the disclosure of which is hereby incorporated by reference.

### BACKGROUND

### Technical Field

The present invention relates to a data analysis system, data analysis method, and data analysis program for analyzing data.

### Background Art

Currently, data relating to various injuries, diseases, and drugs are being accumulated in medical care; and such data continue to grow along with daily advances in the medical care. Therefore, organization of such data is mandatory work.

PTL 1 and PTL 2 disclose, for example, medical information display devices capable of acquiring medical information desired by a user more easily by more intuitive operation by using an intuitive user interface such as a touch panel.

### CITATION LIST

### Patent Literature

PTL 1: Japanese Patent Application Laid-Open (Kokai) Publication No. 2012-048602

PTL 2: Domestic Re-publication of PCT International Application No. 2012-029265

### SUMMARY OF THE CLAIMED INVENTION

### Problems to be Solved by the Invention

However, although the devices disclosed in PTL 1 and PTL 2 are intended to narrow down the desired medical information as appropriate and the user is required to input information for that purpose, there is an enormous amount of data to be input and it requires an immense amount of effort to just sort out the data. For example, regarding drugs, it is required to report information about, for example, adverse events of pharmaceutical products (hereinafter referred to as the “side effects”). Regarding such reports, those who are engaged in the medical care are required to judge whether the relevant adverse events of pharmaceutical products should actually be identified as the side effects or not; however, it requires lots of hard work to just check each report one by one and identify the side effects described in that report.

So, in light of the above-described problem, it is an object of the present invention to provide a data analysis system for accepting unknown data and presenting what kind of event the relevant unknown data is highly related to.

### Means for Solving the Problems

In order to solve the above-described problem, a data analysis system according to an embodiment of the present invention includes: a training data acquisition unit that acquires a combination of training data including information about a medicinal drug and a plurality of pieces of classification information for classifying the training data on the basis of a plurality of classification standards; a learning unit that learns a pattern of the information about the medicinal drug from distribution of data elements which constitute at least part of the training data and appear according to the classification information; an unknown data acquisition unit that acquires unknown data from a specified information source; a data evaluation unit that evaluates the acquired unknown data on the basis of the learned pattern with respect to each of the plurality of classification standards; and a presentation unit that presents the information about the medicinal drug included in the unknown data to a user according to evaluation by the data evaluation unit.

Furthermore, a data analysis method according to an embodiment of the present invention is executed by a computer and includes: a training data acquisition step of acquiring a combination of training data including information about a medicinal drug and a plurality of pieces of classification information for classifying the training data on the basis of a plurality of classification standards; a learning step of learning a pattern of the information about the medicinal drug from distribution of data elements which constitute at least part of the training data and appear according to the classification information; an unknown data acquisition step of acquiring unknown data from a specified information source; a data evaluation step of evaluating the acquired unknown data on the basis of the learned pattern with respect to each of the plurality of classification standards; and a presentation step of presenting the information about the medicinal drug included in the unknown data to a user according to evaluation in the data evaluation step.

Furthermore, a data analysis program according to an embodiment of the present invention has a computer implement: a training data acquisition function that acquires a combination of training data including information about a medicinal drug and a plurality of pieces of classification information for classifying the training data on the basis of a plurality of classification standards; a learning function that learns a pattern of the information about the medicinal drug from distribution of data elements which constitute at least part of the training data and appear according to the classification information; an unknown data acquisition function that acquires unknown data from a specified information source; a data evaluation function that evaluates the acquired unknown data on the basis of the learned pattern with respect to each of the plurality of classification standards; and a presentation function that presents the information about the medicinal drug included in the unknown data to a user according to evaluation by the data evaluation function.

Furthermore, the unknown data acquisition unit may recognize medical personnel as the specified information source and acquire report information reported from the medical personnel as the unknown data.

Furthermore, the unknown data acquisition unit may recognize a database collecting the information about the medicinal drug as the specified information source and acquire information included in the database as the unknown data.

Furthermore, the learning unit may include: an extraction unit that extracts the data elements constituting at least part of the training data from the training data; and a calculation unit that calculates a weighted value of each of the extracted data elements; wherein the pattern of the information about the medicinal drug may be learned by associating each of the extracted data elements with the relevant calculated weighted value.

Furthermore, the extraction unit may extract morphemes relating to an emotional expression as each of the data elements; the calculation unit may calculate a weighted value of the morpheme relating to the emotional expression; and the data evaluation unit may evaluate the unknown data on the basis of the morpheme relating to the emotional expression included in the unknown data with respect to each of the plurality of classification standards.

Furthermore, the data analysis system may further include a memory unit that previously stores related information which is information about a specified medicinal drug; and the presentation unit may further present related information which is estimated to be related to the acquired unknown data, together with the information about the medicinal drug.

Furthermore, the information about the medicinal drug may be information about efficacy or side effects of the medicinal drug.

Furthermore, the information about the medicinal drug may be information about the medical personnel's opinion about a specified viewpoint about the medicinal drug.

### Advantageous Effects of Invention

The data analysis system, data analysis method, and data analysis program according to an embodiment of the present invention present evaluations of the unknown data with respect to each piece of learning data targeted at a plurality of different events, so that the user can recognize to what kind of event the relevant unknown data is highly related, without checking the content of the unknown data.

### BRIEF DESCRIPTION OF DRAWINGS

FIG. 1 is a block diagram illustrating a functional configuration of a data analysis system according to an embodiment;

FIG. 2 is a flowchart illustrating processing for creating teacher data for data analysis;

FIG. 3 is a flowchart illustrating score calculation processing for each piece of learning data when input of unknown data is accepted;

FIG. 4 is a conceptual data diagram illustrating an example of result information;

FIG. 5 is an image diagram illustrating a specific example of an event.

FIG. 6 is an image diagram illustrating a specific example of an event.

FIG. 7 is an image diagram illustrating a specific example of an event.

### DETAILED DESCRIPTION

### Embodiment

An embodiment of a data evaluation system according to the present invention will be described with reference to drawings.

### Outline

Conventionally, there is a system called the Medical Products and Medical Equipment Safety Information Report System that sets forth reporting of drugs and their side effects to medical personnel and supervisory authorities when what appears to be a new side effect is discovered. By utilizing that system, for example, a new side effect of the medical product may sometimes be discovered and identified as the side effect. Generally available medical products in the market are sold as products without side effects after many experiments and clinical tests, but there is a possibility that side effects which can hardly be discovered due to, for example, the number of samples may be latent. The above-mentioned system exists in preparation for a case where such side effects may be discovered. This activity is called pharmacovigilance and means a medical product supervising activity.

However, since there are many reports made by the medical personnel or the like by using the above-mentioned system, it requires much effort to sort them out to judge whether what appears to be a side effect should actually be identified as the side effect or not, whether the relevant drug and the side effect have a causal connection or not, or whether there is any serious report or not. Accordingly, it is very difficult to distinguish, for example, reports which may possibly be highly related to side effects, from those which may be not. Therefore, there has been a desire for the development of a system for supporting this distinguishing of the reports.

Meanwhile, medical portal sites where various information relating to medical care is accumulated are known to provide information related to the medical care; however, there is a wide variety of accumulated information and it is difficult even for the medical personnel to acquire desired information from such accumulated information. For example, assuming that there are pages where various users' comments from the user of a certain drug are accumulated, to pick up necessary important information from those comments by checking the comments one by one would result in a problem of cumbersome and time-consuming work when there are a large number of comments. Conventionally, there are search systems using keywords; however, if the relevant keywords do not exist in the data, there would be no hit for the search even if the data is necessary data. So, there has been a desire for the development of a system capable of distinguishing desired data from a large amount of data flexibly and with high precision.

Therefore, a data analysis system according to this embodiment analyzes to which event among a plurality of events the input data is highly related. In order to do so, the data analysis system: firstly extracts data elements from data related to one event among the plurality of events and from data which is not related to the event; calculates respective weighted values of these data elements; associates the corresponding weighted values with the respective data elements; and stores them as first learning data. This processing is executed for each event to generate as many pieces of learning data as the number of events.

Next, the data analysis system accepts input of unknown data regarding which to which event the relevant data is highly related has not been analyzed. Then, the data analysis system extracts the data elements from the unknown data and calculates an evaluation value (a score which is a value quantifying the relation with the event as indicated by the relevant unknown data and the learning data used to calculate the score) of the unknown data for each piece of learning data on the basis of the weighted values of the data elements as calculated for each piece of learning data.

As a result, the data analysis system can present an index for judging to which event the unknown data is highly related, depending on whether the score is high or low. Therefore, the data analysis system can present the index based on a plurality of standards (training data). So, for example, in a case of drug side effect reports, the data analysis system can suggest a report which reports what appears to be a side effect that should highly possibly be actually identified as the side effect, from among a large number of listed reports. Furthermore, for example, in a case of medical portal sites, the data analysis system can suggest serious information from among a large number of posted comments.

The details of the data analysis system will be explained below.

### Configuration

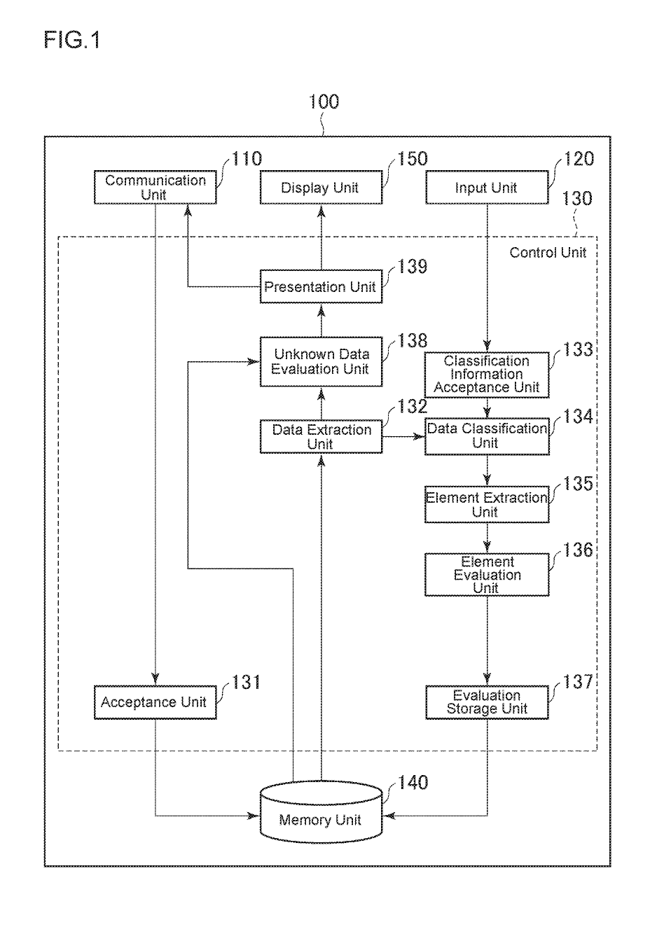

FIG. 1 is a block diagram illustrating a functional configuration of a data analysis system 100.

The data analysis system 100 includes a communication unit 110, an input unit 120, a control unit 130, a memory unit 140, and a display unit 150 as illustrated in FIG. 1.

The communication unit 110 has a function that accesses other devices via a network. Furthermore, the communication unit 110 also has a function that transmits the score of the unknown data transmitted from the control unit 130 to a user terminal when it is possible to establish communications with the user terminal.

The input unit 120 accepts input of information, as classification information, about on what basis classification is performed. Specifically speaking, the classification information is information indicating whether the relevant data is related or not related to a specified event (one of a plurality of events). Furthermore, the input unit 120 has a function that accepts the information indicating whether the relevant data is related to the specified event or not, from the user and transmits it to the control unit 130.

The control unit 130 is a processor having a function that controls each unit of the data analysis system 100 with reference to various kinds of data stored in the memory unit 140. The control unit 130 controls various functions of the data analysis system 100 in an integrating manner.

The control unit 130 includes an acceptance unit 131, a data extraction unit 132, a classification information accepting unit 133, a data classification unit 134, an element extraction unit 135, an element evaluation unit 136, an evaluation storage unit 137, an unknown data evaluation unit 138, and a presentation unit 139.

The acceptance unit 131 has a function that accesses a network (for example, the Internet or the intranet) via the communication unit 110, acquires data on that network, and records the web page information in the memory unit 140. In this example, data handled by the data analysis system 100 mainly indicate data at least partly including texts such as document data (for example, materials about drugs, materials in which side effects of the drugs are described, various kinds of comments exchanged over the web, e-mails, presentation materials, spreadsheet materials, meeting materials, contracts, organization charts, and business plans) and also include a wide variety of arbitrary data such as image data, sound data, and video data. It should be noted that the acceptance unit 131 may be designed to accept data from a connected storage medium (such as a USB memory) via an interface (such as a USB port) of the data analysis system 100.

The data extraction unit 132 has a function that extracts data from data stored in the memory unit 140, as the need arises. The data extraction unit 132 transmits data used to calculate the weighted values of the data elements to the data classification unit 134. Furthermore, the data extraction unit 132 extracts the unknown data, whose score has not been calculated, from the memory unit 140 and transmits it to the unknown data evaluation unit 138.

The classification information accepting unit 133 accepts the classification information for the specified event from the input unit 120.

For example, the specified event herein used may be a “side effect of a drug,” “efficacy evaluation of a drug,” or a “specified topic on a web page” and various events may be relevant. Furthermore, regarding the classification information, for example, in a case of the “side effect of a drug,” it is possible to use the classification information indicating “related to the side effect” or “not related to the side effect”; and in a case of the “efficacy evaluation of a drug,” it is possible to use the classification information indicating “very good,” “good,” “average,” “bad,” and “very bad”; and in a case of the “specified topic on a web page,” it is possible to use the classification information indicating “related to the topic” or “not related to the topic.” The content of classification and the classification information are decided by the user. Furthermore, the number of pieces of classification information is not limited as long as there are at least two levels of classification information as mentioned in the examples above.

The data classification unit 134 determines to which classification information accepted by the classification information accepting unit 133 the data transmitted from the data extraction unit 132 is relevant, on the basis of the input from the input unit 120. The data classification unit 134 classifies the data by associating the classification information, indicating in which classification the data transmitted from the data extraction unit 132 belongs, with the relevant data. The data classification unit 134 transmits the data associated with the classification information to the element extraction unit 135. For example, when the data transmitted from the data extraction unit 132 is related to fever as a side effect of the drug, the data classification unit 134 assigns the classification information indicating that the relevant data is related to the side effect of fever, to the relevant data according to the input from the input unit 120. The data associated (or labeled) with the classification information designated by the user is called “training data.”

The element extraction unit 135 has a function that extracts data elements from the web pages associated with the classification information by the data classification unit 134. Under this circumstance, for example, (1) if the data is document data, the element extraction unit 135 can extract keywords (so-called morphemes), sentences, paragraphs, and so on included in the relevant document data as the data elements; (2) if the data is voice data, the element extraction unit 135 can extract partial voices included in the relevant voice data as the data elements; (3) if the data is image data, the element extraction unit 135 can extract partial images included in the relevant image data as the data elements; and (4) if the data is video data, the element extraction unit 134 can extract frame images (or a combination of a plurality of frame images) included in the relevant video data as the data elements.

The data elements extracted by the element extraction unit 135 are selected by the data analysis system 100 in accordance with specified selection standards. As an example of a method for selecting the data elements under this circumstance, data elements which frequently appear in the relevant training data corresponding to the classification indicated by the classification information may be used. For example, when the classification information is managed by two values indicating that the relevant data is “related to” or “not related to” a specified event, the data elements may be selected by selecting remaining keywords, as the data elements, that are left after removing keywords extracted from training data, which is not related to the specified event, from keywords extracted from training data related to the specified event. Furthermore, the data elements may be designated by the user to the data analysis system 100 by using the input unit 120.

The element evaluation unit 136 has a function that evaluates each data element extracted by the element extraction unit 135 in accordance with a predetermined specified evaluation standard. The element evaluation unit 136 may evaluate the data elements by using, as the specified evaluation standard, a transmitted information amount indicative of a dependency relationship with the classification information with respect to the data elements. For example, when the element extraction unit 135 extracts a keyword as a data element from document information (text) included in a web page, it evaluates that keyword by calculating a weight value of the keyword.

The element evaluation unit 136 calculates the weight of each data element extracted by the element extraction unit 135 in accordance with a specified algorithm. Under this circumstance, the classification information shall be used to execute processing by using the two values indicating that the relevant data is “related to” or “not related to” the specified event in order to provide a simple explanation.

The element evaluation unit 136 can repeatedly re-evaluate an evaluation value of each data element and recalculate the weight of the data element until a calculated score of training data, regarding which the user has judged that the data is related to the specified event, becomes superior to a score of training data regarding which the user has judged that the data is not related to the specified event. Specifically speaking, the element evaluation unit 136 firstly calculates scores of training data on the basis of the weights calculated once. The element evaluation unit 136 arranges the training data according to the scores. When this happens, it is desirable that regarding the evaluation by the data analysis system 100, the training data related to the specified event should be arranged in superior positions and the training data not related to the specified event should be arranged in inferior positions. So, for example, the element evaluation unit 136 executes the calculation until the scores of the training data related to the specified event are arranged in the superior positions and the scores of the training data not related to the specified event are arranged in positions inferior to the above-described scores.

The element evaluation unit 136 uses, for example, the following expression (1) to calculate the weight wgt of data elements.

$$\begin{matrix}Math . 1 & \\ {wgt}_{i , L} = \sqrt{{wgt}_{L - i}^{2} + {γ}_{L} {wgt}_{i , L}^{2} - ϑ} = \sqrt{{wgt}_{i , L}^{2} + {\sum }_{i = 1}^{L} ( {γ}_{L} {wgt}_{i , L}^{2} - ϑ )} & ( 1 )\end{matrix}$$

In the above expression, wgt represents an initial value of the weighted value of an i-th selected keyword before learning. Also, wgt represents the weight of the i-th selected keyword after L-th learning; and γ means a learning parameter for L-th learning and θ means a threshold value of learning effects.

The element evaluation unit 136 associates the calculated weighted values of the respective data elements with those data elements and then transmits them to the evaluation storage unit 137.

The evaluation storage unit 137 has a function that associates the respective data elements transmitted from the element evaluation unit 136 with their weighted values and then stores them in the memory unit 140.

The unknown data evaluation unit 138 has a function that evaluates whether the unknown data transmitted from the data extraction unit 132 is related to the specified event or not, by using the weighted values of the data elements stored in the memory unit 140.

Specifically speaking, the unknown data evaluation unit 138 identifies data elements included in the unknown data (data which is not associated [or not labeled] with the classification information) transmitted from the data extraction unit 132. Then, the unknown data evaluation unit 138 identifies evaluation values of the data elements by referring to the weighted values of the respective data elements stored in the memory unit 140. Subsequently, the unknown data evaluation unit 138 integrates the weighted values of the respective data elements included in the unknown data so as to perform scaling to find a value within a predetermined range (for example, from 0 to 10000), thereby calculating the score of the relevant unknown data.

More specifically, for example, the unknown data evaluation unit 138 generates a data element vector with respect to the data elements extracted from the unknown data. The data element vector is a vector (bag of words) based on whether the evaluated data elements in the memory unit 140 are included in the unknown data or not.

When the data elements associated with the weighted values are included in the unknown data in the memory unit 140, the unknown data evaluation unit 138 changes a corresponding vector value of the data element vector from “0” to “1.” Then, the unknown data evaluation unit 138 thereby generates the data element vector for that unknown data on the basis of the data elements extracted from the unknown data. The unknown data evaluation unit 138 calculates score S of the unknown data by calculating an inner product between the generated data element vector and the evaluation value (weight) of each data element (see the following expression (2)).

Math. 2

S=w^{T}·s (2)

In the above expression, s represents a keyword vector and w represents a weight vector. It should be noted that T means transposition. Incidentally, the unknown data evaluation unit 138 can calculate one score for each piece of unknown data as described above and also calculate one score for each unit by dividing the unknown data by a specified break (such as a sentence, a paragraph, a partial voice divided into a specified length, or a partial moving image including a specified number of frames) (the details will be explained later).

The presentation unit 139 has a function that presents the score of the unknown data as calculated by the unknown data evaluation unit 138. Incidentally, it is mentioned above that the presentation unit 139 presents information about the score of the unknown data to the user; however, this is just one example and in another example, the presentation unit 139 may present web pages in descending order of scores from one with the highest score or may present unknown data of a certain score or higher. The presentation unit 139 transmits presentation information including the unknown data and its score to the communication unit 110 or the display unit 150 as the need arises. For example, when the communication unit 110 is connected to the user's communication terminal so that they can communicate with each other, the presentation unit 139 transmits the presentation information to the communication unit 110; and, in other cases, the presentation unit 139 transmits the presentation information to the display unit 150.

The memory unit 140 is a storage medium having a function that stores necessary programs and various kinds of data to be used by the data analysis system 100 to analyze the data. The memory unit 140 is implemented by, for example, HDDs (Hard Disc Drives), SSDs (Solid State Drives), semiconductor memories, or flash memories. It should be noted that FIG. 1 illustrates the configuration of the data analysis system 100 equipped with the memory unit 140, but the memory unit 140 may be a storage device outside the data analysis system 100 and connected to the data analysis system 100 so that they can communicate with each other. The memory unit 140 associates the data elements with their weighted values and thereby stores them.

The display unit 150 is a monitor having a function that displays images based on display data which is output from the control unit 130. The display unit 150 may be implemented by, for example, an LCD (Liquid Crystal Display), a PDP (Plasma Display Panel), or an organic EL (Electro Luminescence) display. In this embodiment, the display unit 150 displays the score of the unknown data with respect to each piece of learning data transmitted from the presentation unit 139.

### Operation

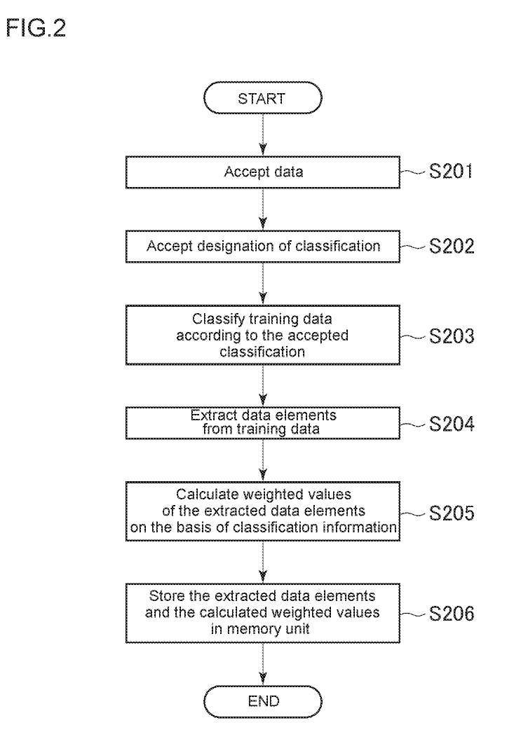

FIG. 2 is a flowchart illustrating the operation of the data analysis system 100 to analyze the training data and calculate evaluations of the data elements.

Referring to FIG. 2, the data extraction unit 132 for the data analysis system transmits the training data to the data classification unit 134 (step S201). Meanwhile, the classification information accepting unit 133 accepts designation of classification for the training data (for example, whether the relevant data is related to the specified event or not) (step S202).

The data classification unit 134 performs classification by associating the training data with the classification information as designated by the user via the input unit 120 (step S203). For example, when accepting the designation indicating that the training data is related to the specified event via the input unit 120, the data classification unit 134 associates the training data with the classification information indicating that it is related to the specified event.

The element extraction unit 135 extracts data elements from the training data (information associated [or labeled] with the classification information indicating whether it relates to the specified event or not, for example, drug efficacy information or case reports on drug side effects) (step S204).

The element evaluation unit 136 evaluates the respective data elements extracted by the element extraction unit 135 and calculates their weighted values (step S205). The element evaluation unit 136 transmits the calculated weighted values to the element evaluation unit 136.

The element evaluation unit 136 calculates weighted values by adding weighted values calculated for other data elements to the above-obtained weighted values of the data elements by using the expression (2) mentioned above (step S206). The element evaluation unit 136 transmits data elements corresponding to the calculated weighted values to the evaluation storage unit 137.

The evaluation storage unit 137 associates the transmitted weighted values and information indicative of the corresponding data elements and stores them as i-th learning data (where i is an integer equal to or more than 0 and a number other than the number associated with learning data which has been stored before then, and is information for identifying the relevant learning data) in the memory unit 140 (step S207).

The data analysis system 100 extracts data elements from data related to the relevant event and data not related to the relevant event with respect to each event, calculates weighted values of the data elements, and generates learning data associated with the data elements. Accordingly, the data analysis system 100 generates and stores the learning data for each necessary event, that is, a plurality of pieces of learning data. As a result, the data analysis system 100 can calculate a score which serves as an index indicative of the relation with the plurality of events.

The data analysis system 100 can calculate and store the weighted values of the data elements by executing the processing illustrated in FIG. 2 as a previous step to evaluate the unknown data.

The above-described operation is the operation of the data analysis system 100 to determine evaluations of the respective data elements. The processing illustrated in FIG. 2 is also processing for acquiring the training data which has been classified (or associated with the classification information) as designated by the user in order to classify the unknown data and extracting a pattern (for example, keywords or conceptually distribution of the keywords or meanings and concepts represented by the training data) included in the relevant training data. As a result of the processing illustrated in FIG. 2, preprocessing for identifying whether the unknown data is related to the specified event or not is completed.

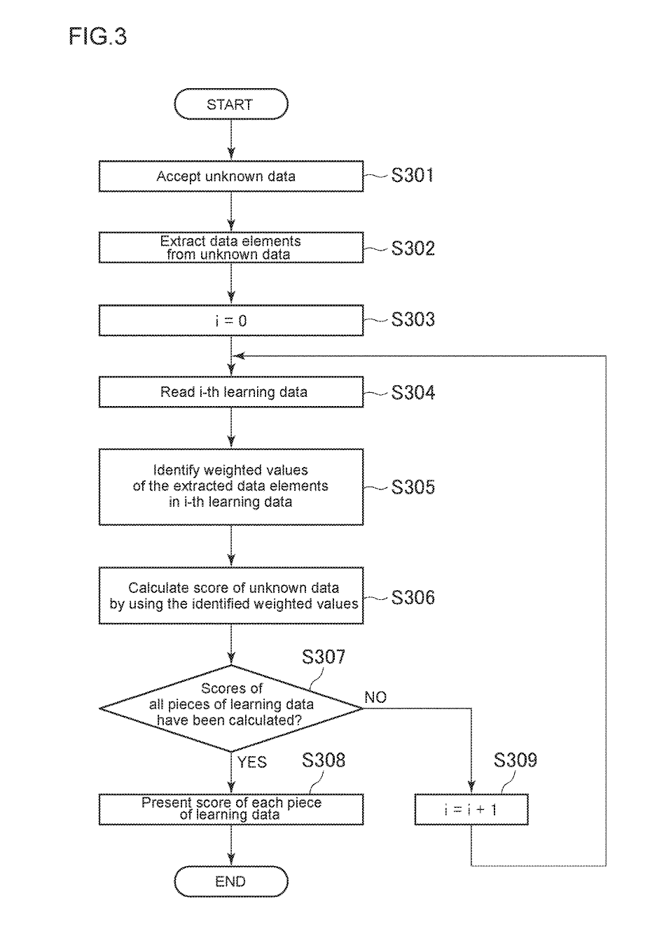

FIG. 3 is a flowchart illustrating the operation of the data analysis system 100 to calculate a score of the unknown data.

Referring to FIG. 3, the unknown data evaluation unit 138 for the data analysis system 100 accepts the unknown data from the data extraction unit 132 (step S301).

The unknown data evaluation unit 138 extracts data elements from the unknown data transmitted from the data extraction unit 132 (step S302).

The unknown data evaluation unit 138 initializes variable i for identifying the learning data to 0 (step S303).

The unknown data evaluation unit 138 reads the i-th learning data from the memory unit 140 (step S304).

The unknown data evaluation unit 138 identifies weighted values associated with the extracted data elements in the i-th learning data and acquires the weighted values from the memory unit 140 (step S305).

Then, the unknown data evaluation unit 138 calculates a score of a web page, from which the relevant data element has been extracted, on the basis of evaluation of each acquired data element (for example, by using the aforementioned expression (2)) (step S306).

The unknown data evaluation unit 138 judges whether scores of all pieces of learning data have been calculated or not, on the basis of whether i is a value less than the number of all the pieces of learning data by 1 or not (step S307).

When the scores of all pieces of learning data have been calculated (YES in step S307), the unknown data evaluation unit 138 associates the calculated score of each piece of learning data with the information of the event indicated by each piece of learning data and transmits it to the presentation unit 139. Then, the presentation unit 139 presents result information which associates information of the transmitted events with the scores to the user (step S308). The result information is transmitted from the presentation unit 139 to the communication unit 110 or the display unit 150 and presented to the user.

On the other hand, when the scores of all pieces of learning data have not been calculated (NO in step S307), the unknown data evaluation unit 138 adds 1 to i (step S309) and returns to step S304.

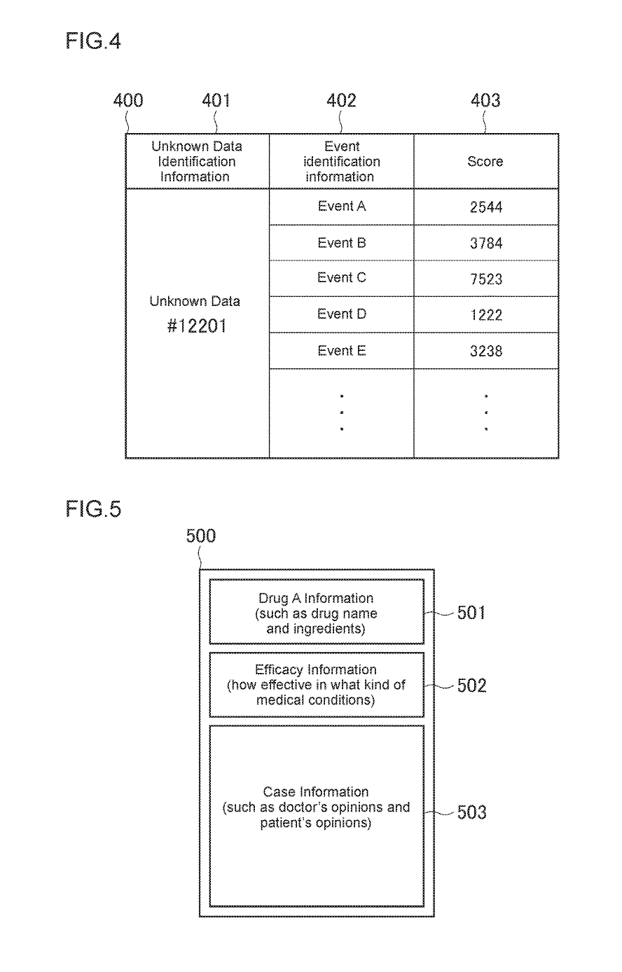

FIG. 4 shows an example of the result information presented by the presentation unit 139.

FIG. 4 is a table illustrating an example of result information 400. Referring to FIG. 4, the result information 400 is a table including unknown data identification information 401, event identification information 402, and a score 403.

The unknown data identification information 401 is unknown data input to the data analysis system 100 and is information for identifying which data the analysis target data is.

The event identification information 402 is information for identifying which event the relevant score corresponds to.

The score 403 is information indicating a score calculated by analysis of the relevant event by the data analysis system 100.

As a result of presenting the result information 400, the user can recognize to which event the unknown data may be highly related. For example, in the example illustrated in FIG. 4, it can be understood that unknown data “#12201” may be highly possibly related to “event C” because that score is higher than scores of other events. Incidentally, FIG. 4 presents the table as an example of the result information 400; however, this may be a graph generated on the basis of the table.

As a result of executing the processing illustrated in FIG. 3, the data analysis system 100 can present an index indicating how highly or lowly the input unknown data is related to each event.

It can be said that the processing illustrated in FIG. 3 is processing for calculating the scores in order to evaluate whether the unknown data is related to a specified event or not. In other words, it can be said that the processing illustrated in FIG. 3 is processing for evaluating the relation between the unknown data and the specified event (for example, whether it is related to a drug, whether it is related to side effects of the drug, or whether it matches a certain viewpoint), by analyzing whether the pattern extracted from the training data is included in the unknown data or not.

### DATA EXAMPLES

Specific examples of the training data and the unknown data will be explained below.

### Example 1

A specific example of the training data and the unknown data will be explained by using FIG. 5.

FIG. 5 is a diagram illustrating a specific example of the training data or the unknown data when classification needs to be performed by checking whether the unknown data is related to side effects of a drug or not. FIG. 5 illustrates an example of side effect information 500 and includes, for example, drug information 501, efficacy information 502, and case information 503.

The drug information 501 is information indicative of basic information about a drug. The basic information herein used may include, for example, information such as the name of the relevant drug, its main ingredients, permission and authorization information, and a manufacturer of the relevant drug.

The efficacy information 502 is information indicating on which injuries or diseases the relevant drug is effective.

The case information 503 is case information about side effects of drug A as indicated in the drug information 501 and includes information such as doctors' opinions and a patient's impressions.

The data analysis system 100 accepts some inputs, as the training data, of the side effect information 500 which is related to some side effects of drug A and the side effect information 500 which is not related to the side effects of drug A as the case information 503, extracts data elements from them and calculates their weighted values, and then stores them as the learning data about the side effects of drug A.

Furthermore, when the data analysis system 100 accepts new case information, it analyzes the content described in the case information 503 and calculates and presents a score indicating to which side effect the relevant information is highly related, with respect to each piece of learning data.

For example, if a word “fatigue” appears in the case information, there is a possibility that the word “fatigue” may be extracted as a data element and associated with a weighted value and that weighted value is stored as learning data. Then, when new unknown data is accepted and data elements are extracted from the unknown data and “fatigue” exists in the data elements, a high score will be presented as information indicating a high possibility that it may indicate a side effect of the relevant drug. Accordingly, when unknown data which appears to be related to side effects of the drug, scores of each piece of learning data for each of many side effects are presented and a score based on learning data of a side effect estimated to be highly related becomes a high value. So, highly related side effects will be found; and regarding any side effect which has not been identified (or discovered), if its score is high, that can be discovered as a new side effect. Furthermore, if scores of the unknown data are low, the unknown data can be classified as those lowly related to the side effects. So, it is possible to reduce time required to view unnecessary reports. Therefore, the data analysis system 100 can classify the unknown data on the basis of whether highly or lowly the unknown data is related to the side effects or what kind of side effects the unknown appears to be highly related, so that it is possible to support classification when reports are made about the side effects of a large number of drugs.

Furthermore, regarding classification to classify whether the unknown data relates to the side effects of a drug or not, a method other than the aforementioned classification of each specified side effect may be used.

For example, learning data may be created by using a plurality of standards, for example, by creating first learning data on the basis of classification of being “related to side effects” or “not related to side effects,” creating second learning data on the basis of classification of being “serious (highly important data as considered by the medical personnel)” or “not serious,” and creating third learning data on the basis of classification of being “related to a specified drug” or “not related to a specified drug”; and a score of the unknown data may be calculated on the basis of each piece of the learning data. In this case, a report with a high score (equal to or more than a certain threshold value) based on all pieces of learning data can be classified as a report which may highly possibly be related to the side effects of the specified drug. Incidentally, the side effects of drugs are used in this example; however, without limitation to the drugs, for example, harmful effects of medical devices may be used.

### Example 2

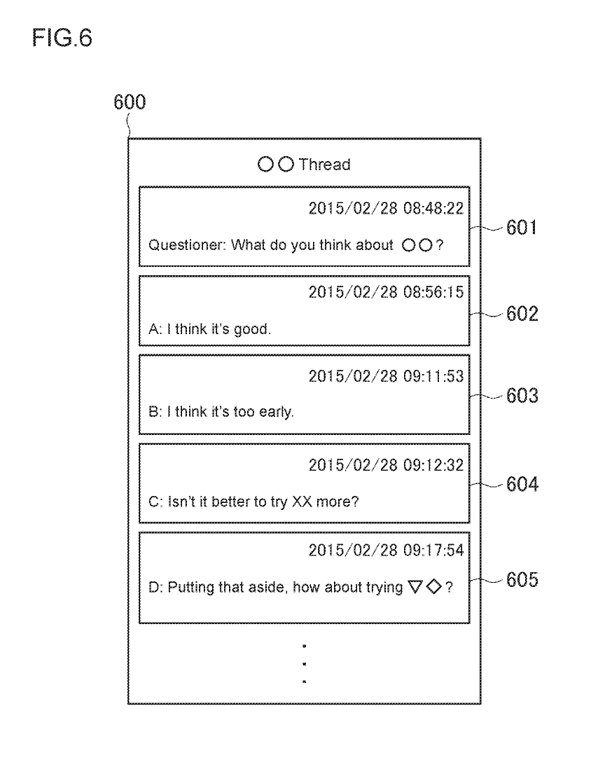

Another specific example of the training data and the unknown data will be explained below by using FIG. 6.

FIG. 6 is a diagram illustrating an example of a web page such as a so-called online bulletin board where various kinds of users' opinions about a viewpoint questioned by a questioner are posted on the Web. The viewpoint in this example relates to medical care such as effects of drugs, chemicals which seem to be necessary to make a desired drug, and effective methods for treatment of a specified injury or disease.

A bulletin board 600 includes comments 601 to 605 from various users. Sorting out these comments to check whether they are really related to the relevant topic or not can be cumbersome work; however, if the data analysis system 100 is used, the index (score) for judging whether each comment is related to the relevant topic or not can be presented. Regarding the comments 601 to 605, some of the comments are related to the topic and some of them are not.

In a case of information like the bulletin board 600, the data analysis system 100 classifies whether each comment is related to the relevant topic or not.

The data analysis system 100 designates some comments related to the topic “XX” and some other comments not related to the topic “XX” with respect to each comment from the users. Then, the data analysis system 100 recognizes the designated comments as training data, extracts data elements, calculates weighted values in accordance with classification information indicating whether it is related to the topic “XX” or not, and stores them in the memory unit 140. As a result, learning data about the topic “XX” is generated.

Furthermore, the data analysis system 100 generates the learning data with respect to other topics in the same manner.

Then, after generating the learning data, the data analysis system 100 calculates and presents an index (score) for judging whether each comment which has not been classified is related to the relevant topic or not.

The use of the data as illustrated in FIG. 6 can be utilized for, for example, development of new drugs or marketing for improvement of drugs. By identifying comments related to the topic (identifying comments with high scores) in the bulletin board 600, it is possible to extract the necessary comments without reading through all comments.

Furthermore, regarding a topic which is not related to a designated topic, but is related to a topic of another learning data, the data analysis system 100 can also present the relation with that learning data as a high score. Specifically speaking, the data analysis system 100 can also evaluate the relation with another topic even among comments in a thread to discuss a certain designated topic. In a case of this example, the data analysis system 100 can be expected to be utilized particularly as a portal site operation system.

Therefore, for example, when a doctor wants to know various opinions about “treatment of hay fever,” it is possible to pick up (or classify and select) comments which may highly possibly and truly discuss the “treatment of hay fever” from among a large amount of hay fever topics if there are a plurality of pieces of learning data such as learning data based on classification of being “related to hay fever” or “not related to hay fever” and learning data based on classification of being “related to treatment” or “not related to treatment.”

### Example 3

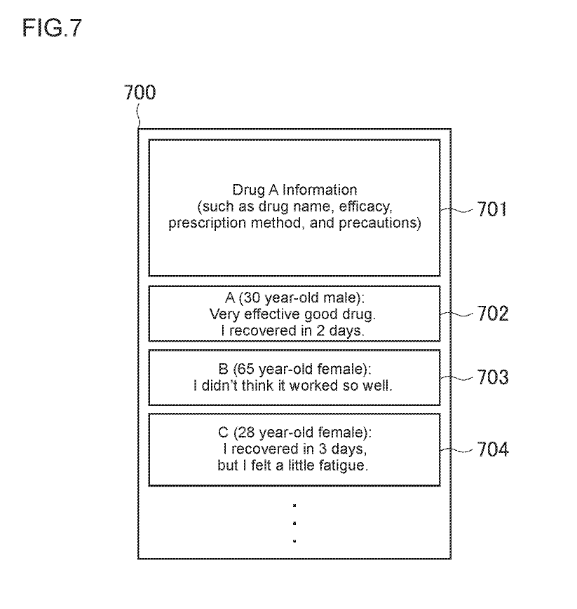

A further specific example of the training data and the unknown data will be explained below by using FIG. 7.

FIG. 7 is a diagram illustrating an example of a web page indicating impressions about the use of a drug by users who used that drug.

Referring to FIG. 7, a web page 700 includes drug information 701 and comments 702 to 704 indicating impressions about the use of a drug indicated in the drug information 701 by users who used that drug.

The drug information 701 is information indicative of basic information about the drug. The basic information in this example may include information such as the name of the drug, its main ingredients, permission and authorization information, a manufacturer, and a prescription method.

The comments 702 to 704 include information such as impressions of the use of the drug by patients who used the drug information 701 and opinions about the relevant drug. It should be noted that the comments may sometimes include comments which are not related to the drug information 701 at all.

When handling such a web page 700, the data analysis system 100 designates some comments related to the drug indicated in the drug information 701 and some comments not related to that drug with respect to the comments and extracts data elements from these comments in the same manner as in (Example 2) described above. Then, the data analysis system 100 calculates weighted values of the extracted data elements and stores them as learning data about drug A in the memory unit 140.

Furthermore, the data analysis system 100 generates learning data about other drugs in the same manner and stores them in the memory unit 140.

Then, the data analysis system 100 presents an index (score) for evaluating the relation between each drug and each comment on each drug. As a result, even when a user intended to comment on their impression about drug A, but actually posted that comment as a comment on drug B, the data analysis system 100 can suggest the possibility that the relevant comment may be about drug A.

For example, if there are learning data created based on classification of “relating to drug A” or “not relating to drug A” and learning data created based on classification of “relating to efficacy” or “not relating to efficacy,” it is possible to classify unknown data with both high scores as data which may highly possibly be related to the efficacy of drug A, from among a plurality of comments; and if there is further learning data created based on classification of “relating to users in their twenties” or “not relating to users in their twenties,” it is also possible to classify and select unknown data which may highly possibly be related to “the efficacy of drug A on users in their twenties.”

### Conclusion

As a result of the above-described processing, the scores which evaluate the relation with a plurality of pieces of learning data relating to medicinal drugs are presented when evaluating unknown data, so that it becomes easier to judge to what kinds of findings of medicinal drugs the input unknown data is highly related. Particularly, there are various kinds of data regarding the efficacy of drugs, side effects of drugs, and viewpoints as indicated in the aforementioned specific examples. So, if only one piece of learning data is used, only the relation with one event can be evaluated and such evaluation would be somehow insecure; however, the data analysis system 100 can be expected to enhance accuracy of multi-perspective analysis of the unknown data by presenting the scores which evaluate the relation with various events.

### Variations

An embodiment of the present invention has been described above; however, it is needless to say that the concept of the present invention is not limited to the embodiment. Various kinds of variations included as the concept of the present invention will be explained below.

(1) In the above-described embodiment, the unknown data evaluation unit 138 calculates the score of unknown data by calculating an inner product between the data element vector and the weight of each data element; however, this calculation method is just an example. The unknown data evaluation unit 138 may calculate the score of the unknown data by using other calculation methods. For example, the unknown data evaluation unit 138 may calculate score S of the unknown data by using the following expression (3) instead of the aforementioned expression (2).

$$\begin{matrix}Math . 3 & \\ S = \frac{{\sum }_{j = 1}^{N} {m}_{j} {w}_{j}^{2}}{{\sum }_{i = 1}^{N} {w}_{i}^{2}} & ( 3 )\end{matrix}$$

In the above expression, mⱼ represents appearance frequency of a j-th keyword and wᵢ represents the weight of an i-th keyword.

(2) In the aforementioned embodiment, the weighted values based on co-occurrence between data elements are calculated; however, a score based on co-occurrence may also be calculated in the step of evaluating the unknown data. The details of such a method will be explained below.

For example, let us assume that a first keyword and a second keyword appear as data elements in unknown data which is an object to be evaluated. Under this circumstance, when the first keyword appears in the unknown data, the unknown data evaluation unit 138 may execute scoring in consideration of the appearance frequency of the second keyword in the relevant unknown data (which may also be referred to as the correlation or co-occurrence between the first keyword and the second keyword).

In this case, the unknown data evaluation unit 138 may calculate the score by using correlation matrix (co-occurrence matrix) C representing the correlation (co-occurrence) between the first keyword and the second keyword according to the following expression (4) instead of the aforementioned expression (2).

Math. 4

S=w^{T}·(C·s) (4)

It should be noted that the above correlation matrix C is optimized in advance by using learning data which includes only a specified number of specified texts. For example, when the keyword “price” appears in a certain text, a value obtained by normalizing the number of appearances of other keywords relative to the relevant keyword between 0 and 1 (which may also be referred to as the maximum likelihood estimate) is stored in an element of the above-mentioned correlation matrix C.

Since the score in consideration of the correlation between the keywords can be calculated by using the expression (4), it is possible to calculate the score of the unknown data with much higher precision.

Incidentally, the co-occurrence relationship is considered here when calculating the score; however, when calculating the weighted values in advance, the weighted values may be calculated in consideration of the co-occurrence relationship. Specifically speaking, after the weighted value of each data element is calculated once, the weighted value of the data element may be calculated by adding a weighted value calculated for another data element (for example, adding a weighted value obtained by multiplication by a specified coefficient) to the weighted value of the data element.

(3) Although the aforementioned embodiment does not include detailed explanations, the unknown data evaluation unit 138 may calculate the score of each piece of partial data included in the unknown data (such as each sentence, paragraph, partial voice divided into a specified length, or partial moving image including a specified number of frames) and then calculate the score of the unknown data based on the above-obtained scores. The details of such a method will be explained below.

The unknown data evaluation unit 138 generates a vector indicating whether or not a specified data element (for example, a keyword) is included in each piece of the partial data, for each piece of the partial data. Then, the unknown data evaluation unit 138 executes scoring of the unknown data according to the following expression (5).

$$\begin{matrix}Math . 5 & \\ S = {w}^{T} \cdot TFnorm ( {\sum }_{i = 1}^{M} C \cdot {s}_{i} ) & ( 5 )\end{matrix}$$

In the above expression, sᵢ represents a vector corresponding to an i-th piece of the partial data. It should be noted that the expression (5) is a mathematical expression in consideration of co-occurrence (the expression uses co-occurrence matrix C). The co-occurrence matrix may not be included.

TFnorm in the above expression (5) can be calculated as indicated in the following expression (6).

$$\begin{matrix} Math . 6 & \\ TFnorm ( {\sum }_{s}^{N} C \cdot {s}_{s} ) = {( 1 + \frac{{\sum }_{s}^{N} {\sum }_{j \neq i}^{n} {c}_{1 j} {s}_{js}}{{TF}_{i}} , 1 + \frac{{\sum }_{s}^{N} {\sum }_{j \neq 2}^{n} {c}_{2 j} {s}_{js}}{{TF}_{2}} , … , 1 + \frac{{\sum }_{s}^{N} {\sum }_{j \neq n}^{n} {c}_{nj} {s}_{js}}{{TF}_{n}} )}^{T} & ( 6 )\end{matrix}$$

Now, in the above expression (6), TFᵢ represents appearance frequency (Term Frequency) of an i-th data element (keyword), sⱼᵢ represents a j-th element of the i-th keyword vector, and cⱼᵢ represents a j-th row, i-th column element of the correlation matrix C.

As a result of integration of the aforementioned expressions (5) and (6), the unknown data evaluation unit 138 can calculate the score of each web page on a partial data score basis by calculating the following expression (7).

$$\begin{matrix}Math . 7 & \\ S = {\sum }_{i = 1}^{n} \{ {w}_{i} ( 1 + \frac{{\sum }_{s}^{N} {\sum }_{j \neq n}^{n} {c}_{ij} {s}_{js}}{{TF}_{i}} ) \} & ( 7 )\end{matrix}$$

In the above expression (7), wᵢ is an i-th element of the weight vector w. Accordingly, the data analysis system 100 can execute scoring which reflects a meaning included in part of data (for example, a meaning of a sentence), so that it can present the score of the unknown data with much higher precision.

(4) In the aforementioned embodiment, the presentation unit 139 presents only the calculated scores; however, the presentation unit 139 may present other data which may possibly be related to the specified event.

For example, the data analysis system 100 associates the generated learning data with related information, which is related to the learning data, and thereby stores them in the memory unit 140. The related information herein used may be, for example, information about side effects, which has already been identified as the side effects of the drugs as in the case of Example 1 described above. Then, the presentation unit 139 may present the related information by associating it with scores of respective events.

(5) Although it is not particularly mentioned in the aforementioned embodiment, emotions of a user who created the unknown data (such as a user who wrote articles on web pages and doctors who prepared case information) may be objects to be evaluated by the element evaluation unit. Specifically speaking, evaluation may be executed by placing importance to words expressing so-called emotions (adjectives and adjective verbs) in the unknown data.

In this case, adjectives and adjective verbs may be designated as the keywords in advance.

A specific example of such an evaluation method will be explained.

The element evaluation unit 136 for the data analysis system 100 firstly associates emotional evaluations with respect to data elements included in the training data (data elements including the user's emotional expressions, for example, morphemes such as “fun” and “sad”) and stores them. For example, the element evaluation unit 136 searches texts included in the training data to check whether predetermined keywords (such keywords are words relating to emotions in a case of texts) are included in the relevant texts or not. If the keywords are included, the element evaluation unit 136 associates the keywords with emotion scores calculated in accordance with a specified standard and stores them in the memory unit 140.

Then, the unknown data evaluation unit 138 extracts the keywords relating to predetermined emotions from unknown data. Then, regarding the extracted keywords, the unknown data evaluation unit 138 refers to the associated emotion scores in the memory unit 140. The unknown data evaluation unit 138 integrates the emotion scores of the respective keywords extracted from the unknown data, thereby obtaining the emotion score of the unknown data.

For example, let us assume that a sentence reciting that “it is great that this drug was highly effective, but it is a little disappointing that it caused a state close to a manic state” is included in the text and “great” and “disappointing” are stored as keywords in the memory unit 140 in advance and they are associated with the emotion scores “+1.4” and “+0.1,” respectively. In this case, the unknown evaluation unit 136 calculates, for example, the emotion score “+1.5” as the emotion score of the relevant text by adding both the above-mentioned scores.

The presentation unit 139 may use the thus-calculated emotion score as the score of the unknown data.

It should be noted that in order to realize the above-described configuration, the data analysis system 100 may include an emotion storage unit that stores the emotion scores of the keywords, and an emotion extraction unit that extracts data elements from unknown data and extracts keywords relating to emotions as the data elements.

(6) The aforementioned embodiment has described an example of analyzing document information (texts); however, voices, images, and videos may be analyzed as mentioned earlier.

For example, in a case of voices, voices themselves may be objects to be analyzed or the analysis may be performed after converting voices into documents by means of voice recognition.

When a voice itself is to be analyzed, the voice is divided into partial voices of a specified length and the partial voices are used as objects to be analyzed. For example, if a voice stating “this film is entertaining” is obtained, the data analysis system 100 can extract the partial voices “film” and “entertaining” from the relevant voice and evaluate the relation between unknown voices and the classification information on the basis of the evaluation result of the partial voices. In such a case, the data analysis system 100 can classify the voice by using chronological data classification algorithms (such as the Markov model and the Kalman filter).

When converting voices into texts, they may be classified in the same manner as indicated in the aforementioned embodiment. Arbitrary voice recognition algorithms (such as a recognition method using the hidden Markov model) may be used for conversion of the voices into the texts.

Alternatively, the data analysis system 100 can analyze moving images. In this case, the data analysis system 100 may extract frame images included in the moving images, analyze the moving images by performing arbitrary pattern matching to see whether an image (such as a thing or a person) as a predetermined data element is included in frames of the moving images or not, and evaluate the relation with the classification information.

(7) Regarding the data analysis system 100 described in the above embodiment, the example in which the data analysis system 100 is used in a medical application system has been explained; however, the data analysis system 100 can be applied to various other systems.

For example, the data analysis system 100 can be applied to an arbitrary system which at least partly deals with data with incomplete structure definitions (unstructured data such as document data including natural languages) such as discovery support systems, forensic systems, mail monitoring systems, Internet application systems, intellectual property search systems, actual performance evaluation systems (project evaluation systems), driving support systems, transaction management systems, call center escalation systems, and marketing systems.

For example, a mail monitoring system will be taken as an example and explained below. When mails about fraudulent acts need to be identified, mails related to fraudulent acts and mails not related to fraudulent acts are prepared in advance as teacher data and data elements are extracted and their weighted values are calculated. The weighted values of the data elements which appear more often in the mails related to the fraudulent acts become higher.

Furthermore, when mails relating to dissatisfaction about an organization, other than the fraudulent acts, need to be identified, mails related to dissatisfaction and mails not related dissatisfaction are prepared in advance as teacher data and data elements are extracted and their weighted values are calculated. The weighted values of the data elements which appear more often in the mails related to the dissatisfaction become higher.

Then, an unknown mail is input and the unknown data evaluation unit 138 calculates a score of the unknown mail by using the weighted values stored in the memory unit 140. Specifically speaking, in this case, the data analysis system presents scores to judge whether the relevant mail relates to a fraudulent act or not and whether the relevant mail relates to dissatisfaction or not.

Furthermore, a discovery support system can be applied to classification of lawsuit-related documents, a forensic system can be applied to classification of investigation documents, an Internet application system can be applied to classification of web pages, and an intellectual property search system can be applied to classification of patent descriptions or the like.

(8) In the aforementioned embodiment, the presentation unit 139 presents the score of each piece of learning data for the unknown data; however, the invention is not limited to this example. The presentation unit 139 may present any information, other than the scores, as knowhow information as long as it can evaluate the unknown data.

For example, when a plurality of pieces of unknown data are input, a score of each pieces of learning data may be calculated for each of the plurality of pieces of unknown data and the unknown data themselves regarding which the score becomes equal to or more than a certain threshold value with respect to all pieces of learning data may be presented. As a result, the data analysis system can present the unknown data which may possibly be highly related to a specified event.

(9) Each functional unit of the data analysis system 100 (information processing apparatus) may be implemented by a logical circuit (hardware) formed on, for example, an integrated circuit (IC chip). Each functional unit of the data analysis system 100 may be implemented by one or more integrated circuits or a plurality of functional units may be implemented by one integrated circuit.

Alternatively, the functions implemented by the respective functional units of the data analysis system 100 may be implemented by software by using a CPU (Central Processing Unit). In this case, the data analysis system 100 includes, for example: a CPU for executing commands of a data analysis program which is software for implementing each function; a ROM (Read Only Memory) or a storage device (collectively referred to as the “storage media”) in which the above-mentioned game program and various kinds of data are recorded in a manner such that they can be read by the computer (or CPU); and a RAM (Random Access Memory) for expanding the above-mentioned data analysis program. Then, the object of the present invention is achieved as the computer (or CPU) reads the above-mentioned data analysis program from the above-mentioned storage media and executes it. As the above-mentioned storage media, “tangible media which are not temporary” such as tapes, disks, cards, semiconductor memories, or programmable logical circuits can be used. Furthermore, the above-mentioned data analysis program may be supplied to the above-mentioned computer via an arbitrary transmission medium capable of transmitting the relevant game program (such as a communication network or a broadcast wave). The present invention can also be implemented in a form of a data signal embedded in a carrier wave in which the above-mentioned data analysis program is embodied via electronic transmission.

It should be noted that the above-mentioned data analysis program can be implemented by using, for example, a script language such as ActionScript or JavaScript (registered trademarks), an object-oriented programming language such as Objective-C or Java (registered trademarks), and a markup language such as HTML5. Furthermore, a distributed data analysis system including an information processing apparatus equipped with the respective units, which implement the respective functions implemented by the above-mentioned data analysis program, and a server equipped with the respective units which implement the remaining functions different from the above-mentioned the respective functions also falls under the category of the present invention.

(10) The present invention has been described with reference to the respective drawings and examples; however, it should be noted that a person skilled in the art could easily make various variations or modifications on the basis of this disclosure. Therefore, it should be noted that these variations and modifications are included in the scope of the present invention. For example, functions or the like included in the respective functional units, the respective steps, and so on can be relocated and it is possible to combine a plurality of means or steps into one means or step or divide them.

(11) The configurations indicated in the aforementioned embodiment and various kinds of variations may be combined as appropriate.

### Supplement

An embodiment of the data evaluation system according to the present invention and its advantageous effects will be described below.

(a) A data analysis system according to the present invention includes: a training data acquisition unit (132, 133) hat acquires a combination of training data including information about a medicinal drug and a plurality of pieces of classification information for classifying the training data on the basis of a plurality of classification standards; a learning unit (134 to 137) that learns a pattern of the information about the medicinal drug from distribution of data elements which constitute at least part of the training data and appear according to the classification information; an unknown data acquisition unit (131, 132) that acquires unknown data from a specified information source; a data evaluation unit (138) that evaluates the acquired unknown data on the basis of the learned pattern with respect to each of the plurality of classification standards; and a presentation unit (139) that presents the information about the medicinal drug included in the unknown data to a user according to evaluation by the data evaluation unit.

Furthermore, a data analysis method according to the present invention is executed by a computer and includes: a training data acquisition step of acquiring a combination of training data including information about a medicinal drug and a plurality of pieces of classification information for classifying the training data on the basis of a plurality of classification standards; a learning step of learning a pattern of the information about the medicinal drug from distribution of data elements which constitute at least part of the training data and appear according to the classification information; an unknown data acquisition step of acquiring unknown data from a specified information source; a data evaluation step of evaluating the acquired unknown data on the basis of the learned pattern with respect to each of the plurality of classification standards; and a presentation step of presenting the information about the medicinal drug included in the unknown data to a user according to evaluation in the data evaluation step.

Furthermore, a data analysis program according to the present invention has a computer implement: a training data acquisition function that acquires a combination of training data including information about a medicinal drug and a plurality of pieces of classification information for classifying the training data on the basis of a plurality of classification standards; a learning function that learns a pattern of the information about the medicinal drug from distribution of data elements which constitute at least part of the training data and appear according to the classification information; an unknown data acquisition function that acquires unknown data from a specified information source; a data evaluation function that evaluates the acquired unknown data on the basis of the learned pattern with respect to each of the plurality of classification standards; and a presentation function that presents the information about the medicinal drug included in the unknown data to a user according to evaluation by the data evaluation function.

As a result, the relation between the unknown data and events associated respectively with a plurality of pieces of learning data can be evaluated, so that the unknown data can be evaluated in a multi-perspective manner.

(b) Regarding the data analysis system according to (a) above, the unknown data acquisition unit may recognize medical personnel as the specified information source and acquire report information reported from the medical personnel as the unknown data. As a result, the data analysis system can evaluate the report information reported from the medical personnel with respect to each of the plurality of classification standards, so that it is possible to support classification of the report information.

(c) Regarding the data analysis system according to (a) or (b) above, the unknown data acquisition unit may recognize a database collecting the information about the medicinal drug as the specified information source and acquire information included in the database as the unknown data.

As a result, the data analysis system can analyze many pieces of information posted at, for example, medical portal sites as unknown data, so that it is possible to support classification to check whether or not the relevant information is information related to desired information from among the numerous pieces of information.

(d) Regarding the data analysis system according to any one of (a) to (c) above, the learning unit may include: an extraction unit (135) that extracts the data elements constituting at least part of the training data from the training data; and a calculation unit (136) that calculates a weighted value of each of the extracted data elements; wherein the pattern of the information about the medicinal drug may be learned by associating each of the extracted data elements with the relevant calculated weighted value (137).

As a result, the data analysis system can learn the pattern of the information by calculating the weighted values of the data elements constituting the data.

(e) Regarding the data analysis system according to any one of (a) to (d) above, the extraction unit may extract a morpheme relating to an emotional expression as each of the data elements; wherein the calculation unit calculates a weighted value of the morpheme relating to the emotional expression; and the data evaluation unit may evaluate the unknown data on the basis of the morpheme relating to the emotional expression included in the unknown data with respect to each of the plurality of classification standards.

As a result, the data analysis system can execute evaluation based on the emotional expressions included in the unknown data. Particularly, since the side effects of medicinal drugs and impressions from use of the medicinal drugs may be affected by subjective views of the medical personnel or the user, it is possible that the evaluation based on the emotional expressions may easily be considered as reliable evaluation to a certain degree. So, the data analysis system can evaluate the unknown data with much higher precision.

(f) Regarding the data analysis system according to any one of (a) to (e) above, the data analysis system may further include a memory unit that previously stores related information which is information about a specified medicinal drug; and the presentation unit may further present related information which is estimated to be related to the acquired unknown data, together with the information about the medicinal drug.

As a result, the data analysis system can present further information, so that the user who saw this can judge the evaluation of the relation between the unknown data and the event more objectively and more accurately.

(g) Regarding the data analysis system according to any one of (a) to (f) above, the information about the medicinal drug may be information about efficacy or side effects of the medicinal drug.

As a result, the data analysis system can support the analysis of information about the efficacy or side effects of the medicinal drug.

(h) Regarding the data analysis system according to any one of (a) to (f) above, the information about the medicinal drug may be information about the medical personnel's opinion about a specified viewpoint about the medicinal drug.

As a result, the data analysis system can support analysis of information about viewpoints regarding medicinal drugs.

### INDUSTRIAL APPLICABILITY

The present invention can be applied to a wide variety of arbitrary computers such as personal computers, server apparatuses, workstations, and mainframes.

1. A data analysis system comprising a computer equipped with a processing unit and a memory and having the computer execute data analysis,
wherein on the basis of a data processing program which is set to the computer, the processing unit:
acquires a combination of training data including information about a medicinal drug and a plurality of pieces of classification information for classifying the training data on the basis of a plurality of classification standards;
learns a pattern of the information about the medicinal drug from distribution of data elements which constitute at least part of the training data and appear according to the classification information;
acquires a plurality of object data, to which the data analysis is applied, from a specified information source;
evaluates the acquired plurality of object data on the basis of the learned pattern with respect to each of the plurality of classification standards, wherein the evaluation includes scoring each of the plurality of object data; and
presents the information about the medicinal drug included in each of the plurality of object data to a user according to evaluation of the acquired plurality of object data, wherein the presentation includes ranking the plurality of object data.

2. The data analysis system according to claim 1, wherein the acquisition of the object data by the processing unit includes recognizing medical personnel as the specified information source and acquiring report information reported from the medical personnel as the unknown data.

3. The data analysis system according to claim 1, wherein the acquisition of the object data by the processing unit includes recognizing a database collecting the information about the medicinal drug as the specified information source and acquiring information included in the database as the unknown data.

4. The data analysis system according to claim 1,
wherein the learning by the processing unit includes:
extracting the data elements constituting at least part of the training data from the training data; and
calculating a weighted value of each of the extracted data elements;
wherein the pattern of the information about the medicinal drug is learned by associating each of the extracted data elements with the relevant calculated weighted value.

5. The data analysis system according to claim 1,
wherein the extraction by the processing unit includes extracting a morpheme relating to an emotional expression as each of the data elements;
wherein the calculation by the processing unit includes calculating a weighted value of the morpheme relating to the emotional expression; and
wherein the evaluation by the processing unit includes evaluating the object data on the basis of the morpheme relating to the emotional expression included in the object data with respect to each of the plurality of classification standards.

6. The data analysis system according to claim 1,
wherein the processing unit further previously stores related information which is information about a specified medicinal drug; and
wherein the presentation by the processing unit further includes presenting related information which is estimated to be related to the acquired unknown data, together with the information about the medicinal drug.

7. The data analysis system according to claim 1, wherein the information about the medicinal drug is information about efficacy or side effects of the medicinal drug.

8. The data analysis system according to claim 1, wherein the information about the medicinal drug is information about the medical personnel's opinion about a specified viewpoint about the medicinal drug.

9. A method for having a computer evaluate data executed by a processing unit included in the computer, the method comprising:
a training data acquisition step of acquiring a combination of training data including information about a medicinal drug and a plurality of pieces of classification information for classifying the training data on the basis of a plurality of classification standards;
a learning step of learning a pattern of the information about the medicinal drug from distribution of data elements which constitute at least part of the training data and appear according to the classification information;
an object data acquisition step of acquiring a plurality of object data, to which analysis is applied, from a specified information source;
a data evaluation step of evaluating the acquired plurality of object data on the basis of the learned pattern with respect to each of the plurality of classification standards wherein the evaluation includes scoring each of the plurality of object data; and
a presentation step of presenting the information about the medicinal drug included in each of the plurality of object data to a user according to evaluation in the data evaluation step wherein the presentation includes ranking the plurality of object data.

10. A non-transitory computer readable storage medium having embodied thereon a command for having a computer evaluate data, wherein the command includes:
a training data acquisition function that acquires a combination of training data including information about a medicinal drug and a plurality of pieces of classification information for classifying the training data on the basis of a plurality of classification standards;
a learning function that learns a pattern of the information about the medicinal drug from distribution of data elements which constitute at least part of the training data and appear according to the classification information;
an object data acquisition function that acquires a plurality of object data, to which analysis is applied, from a specified information source;
a data evaluation function that evaluates the acquired plurality of object data on the basis of the learned pattern with respect to each of the plurality of classification standards, wherein the evaluation includes scoring each of the plurality of object data; and a presentation function that presents the information about the medicinal drug included in each of the plurality of object data to a user according to evaluation by the data evaluation function, wherein the presentation includes ranking the plurality of object data.
